(19) United States
(12) Patent Application Publication
(10) Pub. No.: US 2018/0130052 A1
(43) Pub. Date: May 10, 2018

(54) SYSTEMS AND METHODS FOR PERFORMING CARD AUTHENTICATION READS

(71) Applicant: Trusona, Inc., Scottsdale, AZ (US)

(72) Inventor: Ori Eisen, Scottsdale, AZ (US)

(21) Appl. No.: 15/692,674

(22) Filed: Aug. 31, 2017

Related U.S. Application Data
(63) Continuation of application No. PCT/US2016/021062, filed on Mar. 4, 2016.
(60) Provisional application No. 62/128,482, filed on Mar. 4, 2015.
(60) Provisional application No. 62/239,744, filed on Oct. 9, 2015.

(51) Int. Cl. G06Q 20/38; G07F 7/08; G06Q 20/40; G06Q 20/34

(52) U.S. Cl. CPC G06Q 20/3821; G06Q 20/347; G06Q 20/4014; G07F 7/0873

(57) ABSTRACT

A request may be received to perform a card authentication read. A card reader may be used to collect data from a card that is read by the card reader. The data from the card may comprise (1) a magnetic fingerprint of the card, or (2) a swipe characteristic of the card when the card is read by the card reader. A card reader identifier may be received from the card reader. A decision is made to determine whether to approve or reject the card authentication read based on (1) the data from the card and (2) the card reader identifier.

### CROSS-REFERENCE TO RELATED APPLICATIONS

This application is a continuation application of International Patent Application PCT/US2016/021062, filed Mar. 4, 2016, which claims the priority and benefit of U.S. Provisional Application Nos. 62/128,482 filed on Mar. 4, 2015 and 62/239,744 filed on Oct. 9, 2015, the entire contents of which are incorporated herein by reference.

### BACKGROUND OF THE INVENTION

Card theft and identity theft play large roles in fraudulent activities (e.g., fraudulent transactions). Both theft of a physical card and skimming of data on a card to create a clone permit fraudsters to assume a false identity for the purposes of an identity authentication and/or a financial transaction.

This becomes particularly concerning in situations involving identity verification and/or large financial transactions. Particularly, users can conduct identity authentications or financial transactions online and fairly anonymously. Oftentimes, users can register themselves without validation, and use basic card information to conduct identity authentications and/or financial transactions. The use of stolen cards or stolen card data would not be detectable in traditional online authentications.

### SUMMARY OF THE INVENTION

Systems and methods are provided for performing an authentication using card authentication read data and card reader identifier. For instance, a card reader may be utilized during an authentication or a financial transaction to collect various data. For example, the card reader may be able to read and distinguish magnetic information on the card which may be unique to each card. The card reader may also be able to record card swipe characteristics, which may be used to distinguish users. For instance, different users may swipe cards through a card reader in different manners. The card reader identifier may also be collected for verifying the authentication. The card reader identifier may be helpful in identifying a fraud because a unique card reader identifier may be associated with a card, a user and/or a user device. This correspondence may allow for verification of the authentication, which may provide reduced likelihood of card identification theft. During various steps of an authentication, a request to perform an authentication read may be initiated and processed by an authentication server, a user device, and/or a third-party entity within a system. The collected data may be compared with corresponding data from historic authentications and/or user registration data to determine whether the authentication is fraudulent. The authentication read may be performed on a user device using a separate mobile application or within the same application used for a transaction.

An aspect of the invention is directed to a method of authenticating an online transaction or a log-in process. The method comprises: receiving a request to perform a secure authentication step during the online transaction or the log-in process, wherein the secure authentication step is performed when a card having a magnetic stripe is swiped through a card reader; receiving data collected about the card from the card reader, wherein said data is collected via a magnetic head on the card reader and comprises (i) a magnetic fingerprint of the magnetic stripe on the card, and (ii) at least one swipe characteristic associated with the swiping motion of the card; receiving a card reader identifier from the card reader; comparing, with aid of one or more processors, (1) the magnetic fingerprint of the magnetic stripe to a prestored magnetic fingerprint, (2) the at least one swipe characteristic to a prestored swipe characteristic, and (3) the card reader identifier to a prestored card reader identifier; and determining, with the aid of the one or more processors, whether to approve or reject the online transaction or the log-in process based on a match: (1) between the magnetic fingerprint of the magnetic stripe and the prestored magnetic fingerprint, (2) between the at least one swipe characteristic and the prestored swipe characteristic, and (3) between the card reader identifier and the prestored card reader identifier.

Another aspect of the invention is directed to a system for authenticating an online transaction or a log-in process. The system comprises: a server in communication with a card reader operably coupled to a user device, wherein the server comprises (i) a memory for storing a prestored magnetic fingerprint, a prestored swipe characteristic, a prestored card reader identifier, and a first set of software instructions, and (ii) one or more processors configured to execute the first set of software instructions to: receive a request from the user device to perform a secure authentication step during the online transaction or the log-in process, wherein the secure authentication step is performed when a card having a magnetic stripe is swiped through the card reader; receive data collected about the card from the card reader or the user device, wherein said data is collected via a magnetic head on the card reader and comprises (i) a magnetic fingerprint of the magnetic stripe on the card, and (ii) at least one swipe characteristic associated with the swiping motion of the card; receive a card reader identifier from the card reader or the user device; compare (1) the magnetic fingerprint of the magnetic stripe to the prestored magnetic fingerprint, (2) the at least one swipe characteristic to the prestored swipe characteristic, and (3) the card reader identifier to the prestored card reader identifier; and determine whether to approve or reject the online transaction or the log-in process based on a match: (1) between the magnetic fingerprint of the magnetic stripe and the prestored magnetic fingerprint, (2) between the at least one swipe characteristic and the prestored swipe characteristic, and (3) between the card reader identifier and the prestored card reader identifier. The user device comprises a memory for storing a second set of software instructions, and one or more processors configured to execute the second set of software instructions to: transmit the request to the server; receive a result indicative of an approval or a rejection of the online transaction or the log-in process; and display the result visually on a graphical display of the user device.

A further aspect of the invention is directed to a tangible computer readable medium storing instructions that, when executed by one or more servers, causes the one or more servers to perform a computer-implemented method for authenticating an online transaction or a log-in process. The method comprises: receiving a request via a user device to perform a secure authentication step during the online transaction or the log-in process, wherein the secure authentication step is performed when a card having a magnetic stripe is swiped through a card reader operably coupled to the user device; receiving data collected about the card from the card reader or the user device, wherein said data is collected via a magnetic head on the card reader and comprises (i) a magnetic fingerprint of the magnetic stripe on the card, and (ii) at least one swipe characteristic associated with the swiping motion of the card; receiving a card reader identifier from the card reader or the user device; comparing (1) the magnetic fingerprint of the magnetic stripe to a prestored magnetic fingerprint, (2) the at least one swipe characteristic to a prestored swipe characteristic, and (3) the card reader identifier to a prestored card reader identifier, wherein the prestored magnetic fingerprint, the prestored swipe characteristic, and the prestored card reader identifier are stored in a memory unit in communication with the one or more servers; determining, with the aid of the one or more processors, whether to approve or reject the online transaction or the log-in process based on a match: (1) between the magnetic fingerprint of the magnetic stripe and the prestored magnetic fingerprint, (2) between the at least one swipe characteristic and the prestored swipe characteristic, and (3) between the card reader identifier and the prestored card reader identifier; transmitting a result indicative of an approval or a rejection of the online transaction or the log-in process to the user device; and displaying the result visually on a graphical display of the user device.

Additional aspects and advantages of the present disclosure will become readily apparent to those skilled in this art from the following detailed description, wherein only exemplary embodiments of the present disclosure are shown and described, simply by way of illustration of the best mode contemplated for carrying out the present disclosure. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 shows an example of a card reader attached to a user device, in accordance with an embodiment of the invention.

FIG. 2 shows examples of cards with corresponding magnetic strips which are used for authentications, in accordance with an embodiment of the invention.

FIG. 3 shows examples of various swipe characteristics of cards used for authentications, in accordance with an embodiment of the invention.

FIG. 4 shows a schematic system overview of various authentications, in accordance with an embodiment of the invention.

FIG. 5 shows examples of data that may be stored for various authentications, in accordance with an embodiment of the invention.

FIG. 6 shows an example of a user device used for verifying various authentications, in accordance with an embodiment of the invention.

### DETAILED DESCRIPTION OF THE INVENTION

While preferable embodiments of the invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention.

The invention provides systems and methods for performing authentications using card authentication read data and card reader identifier. Various aspects of the invention described herein may be applied to any of the particular applications set forth below. The invention may be applied as a standalone card reading system or as a component of an integrated transaction or fraud detection software. It shall be understood that different aspects of the invention can be appreciated individually, collectively or in combination with each other.

Various activities may be conducted online, such as online registrations, login processes, or online transactions, where users may often be anonymous. For instance, users may often register themselves without validation or using minimal personalized information. Users may provide identity information, such as name and identity card number remotely. Users may also provide financial information, such as card information remotely. Even if users do personally swipe cards at a card reader, they may be using stolen or skimmed identity information and/or card information. Systems and methods provided herein utilize information from an authentication read of a card at a card reader to confirm user identity. For instance, the magnetic fingerprint of the card may be unique to the card, and may be read using the card reader. This may allow the card to be distinguished from skimmed cards, where the data may be duplicated, but the magnetic stripe characteristics may not. Similarly, the swipe characteristics of the card may be read, and may be unique to individual users. Even if the same physical card is used, different users may be distinguished from one another by their swipe characteristics. Even for the same user, between multiple swipes, some very slight variation in the swipe characteristics may be expected. If a card swipe is completely identical this may be indicative that earlier swipe data was recorded and somehow replayed as subsequent swipe.

A card reader may be registered to be owned by a user to perform authentication reads for various activities (e.g., a login process or a transaction). The card reader may be utilized to perform an authentication read of a card. The card reader may have a unique card reader identifier. The card reader identifier may be associated with a card, a user and/or a user device. This correspondence may be helpful in identifying fraudulent authentications and allow for verification of the authentication. The card reader may collect magnetic fingerprint of a card and/or swipe characteristics of a user, and provide card reader identifier for secure authentication. The collected data may be compared with corresponding data from historic authentications and/or user registration data to determine whether the authentication is fraudulent and/or raise a red flag. The authentication read may be performed on a user device using a separate mobile application or within the same application used for a transaction. The transaction may be verified by a user device, an authentication server, a third-party transaction entity, or combinations thereof within an authentication system. Alerts may be provided to various parties as needed if certain conditions are detected.

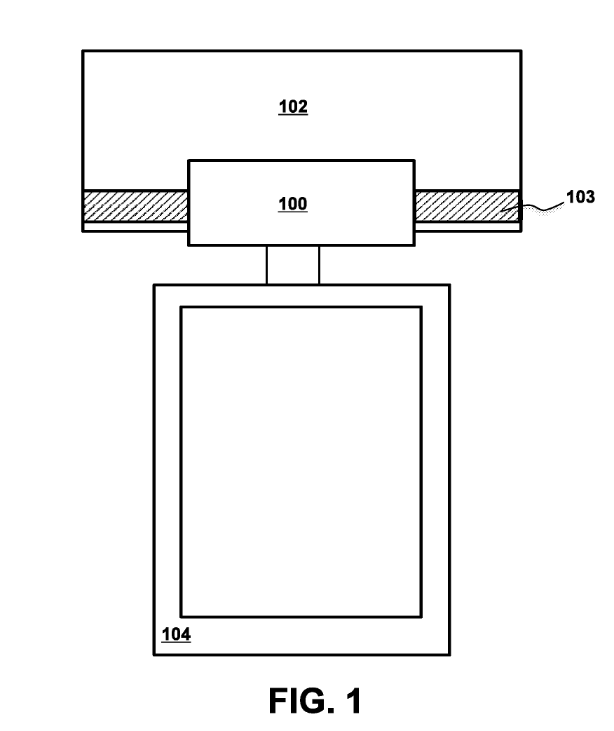

FIG. 1 shows an example of a card reader 100 coupled with a user device 104, in accordance with an embodiment of the invention. In some embodiments, the card reader may be physically connected to the user device. Alternatively, the card reader may be in wireless communication with the user device. The card reader may be configured to read a magnetic component (e.g., a magnetic stripe) 103 of a card 102.

In some embodiments, the user device 104 may be an electronic device capable of forming a connection or communicating with the card reader. The user device may be a mobile device (e.g., smartphone, tablet, pager, personal digital assistant (PDA)), a computer (e.g., laptop computer, desktop computer, server, handheld computer), or any other type of device. The user device may optionally be portable. The user device may be handheld. The user device may be a register at a store or other establishment. The register may be used during authentications (such as financial transactions) at the store or other establishments. The user device may be a network device capable of connecting to a network, such as a local area network (LAN), wide area network (WAN) such as the Internet, a telecommunications network, a data network, or any other type of network.

In some embodiments, the user device may have a user device identifier (UDI) that can be unique to each user device. The user device identifier may comprise a string of characters, which may include a certain number of numerals, a certain number of letters (uppercase letters and/or lowercase letters), a certain number of symbols, or combinations thereof. The user device identifier may include a serial number of the user device, an international mobile station equipment identifier (IMEI), and/or a mobile equipment identifier (MEID). The user device identifier may also include identifying information of the various chipset or other types of hardware within the user device. The user device identifier may further include identifying information of the software (e.g., operating system or software applications) that run on the user device. The user device identifier may comprise identifying information related to the network communication modules (e.g., MAC address). In some embodiments, the user device identifier may comprise identifying information that can be used to represent a user device used for authenticating a card read.

In some embodiments, a user device identifier may be generated when a user device is registered with a transaction system, an authentication system, or a transaction entity, or first connects with a transaction system, an authentication system, or a transaction entity. A user device identifier may be generated when a mobile application for authenticating a card read is downloaded, installed, or running on the user device for the first time. A user device identifier may be generated when a card reader is first connected to the user device, registered with the user device, or used in combination with the user device for a card read authentication. A user device identifier may be generated when a user account is registered with a transaction system, an authentication system, or a transaction entity, and the user device identifier may correspond to the user device used for registration of the user account. In some embodiments, when the user device identifier includes identifying information of hardware on-board the user device, the user device identifier may be generated during manufacturing and/or testing of the user device at the manufacture. In some embodiments, when the user device identifier includes identifying information of software that run on the user device (e.g., an operating system or a web browser), the user device identifier may be generated during downloading, installing or using the software for the first time on the user device. In some embodiments, when the user device identifier includes identifying information related to the network communication interface, the user device identifier may be generated when a corresponding network interface controller is manufactured and stored on-board hardware of the user device.

Once a user device identifier has been generated, it may be stored with other user account information and/or authentication read information. The user device identifier may be stored in one or more memory units. The user device identifier may be stored in cookies, caches, browsing histories, and/or browser fingerprint. The user device identifier may be stored in a memory on-board the card reader or on-board the user device. The user device identifier may be stored on the infrastructure of a transaction system, an authentication system, or a transaction entity. The user device identifier may be distributed over multiple devices/systems (e.g., peer-to-peer, cloud-computing based infrastructure, between the card reader and an external device), or other device/system of any of the types described herein.

In some embodiments, the user device identifier may be generated on-board the user device and stored on-board the user device, the card reader, an external device, or distributed over multiple devices. In other embodiments, the user device identifier may be generated on-board an external device and may be stored on-board the external device, the user device, the card reader, or distributed over multiple devices. The one or more memory units may include databases. A single copy of the user device identifier may be stored, or multiple copies may be stored. The multiple copies may be stored at different memory units. For instance, the multiple copies may be stored on difference devices (e.g., first copy on-board a card reader, and second copy on-board an external device).

In some embodiments, during a card read authentication, the user device identifier may be transmitted to the card reader when a card reader is connected to the user device. The user device identifier may be transmitted to a transaction system, an authentication system, or a transaction entity when the user device is used for authenticating a card read for a transaction. For example, the user device identifier may be transmitted to a transaction system, an authentication system, or a transaction entity when a user uses the user device to login to the user account registered at the transaction system, authentication system, or transaction entity.

The user device may comprise memory storage units which may comprise non-transitory computer readable medium comprising code, logic, or instructions for performing one or more steps. The user device may comprise one or more processors capable of executing one or more steps, for instance in accordance with the non-transitory computer readable media. The user device may comprise a display showing a graphical user interface. The user device may be capable of accepting inputs via a user interactive device. Examples of such user interactive devices may include a keyboard, button, mouse, touchscreen, touchpad, joystick, trackball, camera, microphone, motion sensor, heat sensor, inertial sensor, or any other type of user interactive device. The user device may be capable of operating one or more software applications. One or more applications may or may not be related to the operation of the card reader.

The card 102 may be any type of device that may include a magnetic component (e.g., the magnetic stripe 103) that may be used to identify the device. The magnetic component may be printed or layered onto the substrate. The magnetic component may be embedded into the substrate. The card may be a credit card, debit card, gift card, bank card, discount card, membership card, identity card (e.g., driver license), insurance card, or any other type of card. The card may be tied to a user account. The user account may or may not include information about the user (e.g., user identity, user profile data), or any other information pertaining to the user or user account as described elsewhere herein. The user account may also be a financial account for a user that may include information about credits and/or debits of the user.

The data encoded within the stripe may include information about a card, a user (e.g., a card holder) of the card, or an account associated with the card (e.g., a financial account). The information about the card may include a card type (e.g., credit card, membership card, identity card, etc.), a card issuer (e.g., a credit carrier, a company, the government, etc.), a credit carrier type (e.g., Visa, Mastercard, American Express, Discover, etc.), a card number, a card expiration date, and/or a card security code (e.g., a credit card security code that is usually printed on the back of the card). The information about a user of the card may include information such as the user's name, user's mailing address, user's telephone number, user's email address, user's birthdate, user's gender, user's social security number, or any other personal information about the user. In some embodiments, the information about a financial account associated with the card may include information such as account number, institution for the account (e.g., bank, store, entity, or financial institution), balance information, credit or payment limit information, or any other information associated with the account.

The magnetic fingerprint data may relate to data about a magnetic make-up of the magnetic stripe of the card. This may include information pertaining to remnant noise characteristic information for the magnetic medium of the stripe. Magnetic stripes may include magnetic transitions (e.g., north to south, or south to north). Individual magnetic particles may be provided on the magnetic stripe. There may be inherent variations in and orientation of these magnetic particles that may account for magnetic characteristics of the stripe. These magnetic characteristics may form a magnetic fingerprint, which may be substantially unique for each magnetic stripe.

In some embodiments, the card reader 100 may include a groove or channel through which a card is swiped. In some embodiments, the card reader may include a sensing unit that may be configured to detect the magnetic stripe 103 and obtain magnetic characteristics from the magnetic stripe of the card. The sensing unit may produce a signal indicative of information gathered regarding the magnetic stripe. The information may include data encoded within the stripe and/or magnetic fingerprint data of the stripe.

In other embodiments, the sensing unit may be provided on a side of the card reader, such as an exterior surface of the card reader. The card may be passed over the side and/or the sensing unit. The card may be held over the side and/or the sensing unit, or may be swiped over the side and/or sensing unit. In some embodiments, the card may be tapped against the card reader such that the sensing unit of the card reader may detect and obtain the encoded data and magnetic fingerprint data from the magnetic stripe. In some embodiments, the card may be present within a detectable range of the sensing unit such that the sensing unit may detect and obtain the encoded data and magnetic fingerprint data from the magnetic stripe.

In some embodiments, a mechanical connection may or may not be formed between the user device and the card reader. An electrical connection may or may not be formed between the user device and the card reader. A communication connection may be formed between the user device and the card reader. For example, the card reader may be connected to the user device via a flexible or a rigid connecting member (e.g., tether, wire, cable) by plugging the connecting member into one or more ports on any side(s) of the user device. The connecting member may be used for exchanging information (e.g., card information, account information, card reader identifier, swipe characteristics, user device identifier) between the card reader and the user device. In some alternative embodiments, the card reader may be in wireless communication with the user device to exchange various information. Various embodiments of the card reader and interaction between the card reader and the user device are described in U.S. Provisional Application Nos. 62/204,612 filed on Aug. 13, 2015, and 62/239,676 filed on Oct. 9, 2015, the disclosures of which are incorporated herein by reference in their entity.

In some embodiments, the card reader may have a card reader identifier (CRI) that can be unique to each card reader. The card reader identifier may include various identifying information related to the hardware (e.g., a serial number of the card reader or a component of the card reader), software (e.g., operating system), and/or network communication interface of the card reader. The card reader identifier may include a string of characters, which may comprise a certain number of numerals, a certain number of letters (uppercase letters and/or lowercase letters), a certain number of symbols, or combinations thereof.

The card reader identifier may be generated when a network communication is established between the card reader and the user device, the card reader is first connected to a user device, registered with a user device, or used in combination with a user device for a card read authentication. The card reader identifier may be generated when the card reader is registered with a transaction system, an authentication system, or a transaction entity. The card reader identifier may be generated when the card reader first connects with a transaction system, an authentication system, or a transaction entity. The card reader identifier may be generated when a user account is registered with a transaction system, an authentication system, or a transaction entity. In some embodiments, when the card reader identifier includes identifying information of hardware on-board the card reader, the card reader identifier may be generated during manufacturing and/or testing of the card reader at the manufacture. In some embodiments, when the card reader identifier includes identifying information of software that run on the card reader (e.g., an operating system), the card reader identifier may be generated during downloading, installing or using the software for the first time on the card reader. In some embodiments, when the card reader identifier includes identifying information related to the network communication interface, the card reader identifier may be generated when a corresponding network interface controller is manufactured. The card reader identifier may be a permanent identifier associated with the hardware, or an alterable identifier that may be changed when used by different users or registered to be associated with different users.

Once a card reader identifier has been generated, it may be stored in one or more memory units. The card reader identifier may be stored in a memory on-board the card reader. The card reader identifier may be stored on a memory on-board the user device connected with the card reader. The card reader identifier may be stored on the infrastructure of a transaction system, an authentication system, or a transaction entity. The card reader identifier may be distributed over multiple devices/systems (e.g., peer-to-peer, cloud-computing based infrastructure, between the card reader and an external device), or other device/system of any of the types described herein.

In some embodiments, the card reader identifier may be generated on-board the card reader and stored on-board the card reader, the user device, an external device, or distributed over multiple devices. In other embodiments, the card reader identifier may be generated on-board an external device and may be stored on-board the external device, the user device, the card reader, or distributed over multiple devices. The one or more memory units may include databases. A single copy of the card reader identifier may be stored, or multiple copies may be stored. The multiple copies may be stored at different memory units. For instance, the multiple copies may be stored on difference devices (e.g., first copy on-board a card reader, and second copy on-board an external device).

In some embodiments, during a card read authentication, the card reader identifier may be transmitted to the user device when a card reader is connected to the user device. The card reader identifier may be transmitted to a transaction system, an authentication system, or a transaction entity when the card reader is used for authenticating a card read for a transaction. For example, the card reader identifier may be transmitted to a transaction system, an authentication system, or a transaction entity when a user uses the card reader to authenticate a card read for a transaction with the transaction system, authentication system, or transaction entity.

In some instances, the card reader may be powered by the user device. In one example, the power may be provided through a connecting member. In another example, the card reader may be wirelessly powered by the user device through non-radiative or radiative wireless powering. For instance, non-radiative or near-field wireless powering may occur over a short distance by use of magnetic fields (e.g., inductive charging). Radiative or far-field wireless powering may occur using power beaming, such as beams of electromagnetic radiation, such as microwaves or laser beams. Alternatively, the card reader may have its own local power source (e.g., a local on-board power unit) without being powered by the user device. In some embodiments, the card reader may be of a portable size to be easily carried and connected to the user device. The card reader may be a handheld item.

In some embodiments, the card reader may comprise memory storage units which may comprise non-transitory computer readable medium comprising code, logic, or instructions for performing one or more steps. The card reader may comprise one or more processors capable of executing one or more steps, for instance in accordance with the non-transitory computer readable media. The card reader may also include input/output (I/O) interface to permit communication of the card reader with one or more external device (e.g., a user device).

The card reader may be used to identify a card that is swiped through the card reader and/or a user associated with the card. In some instances, the identification of the card may include verification of an asserted identity of a card and/or user. In other instances, the identification of the card may include determining an identity of the card and/or user without a previous assertion, based on the historical data. A card may be swiped through the card reader for the identification. The identification of the card may occur for any purpose, which may or may not include the facilitation of a transaction. In some instances, the identification may occur to allow a user access to information or a place. Rather than just entering a card number or other card information on a user display of the user device, the card may be read by the card reader. The relevant information may be read from the card via the card reader and used to perform the identification. The card reader may be communicating with a user device that may be facilitating the identification. The user device may receive the card information from the card reader and aid facilitating the identification process. The may occur online or have an online component. The card reader may provide an additional level of security compared to entering in card information manually.

In some embodiments, an authentication read for the card may be performed when the card is read by a card reader. The authentication read may result in obtaining a magnetic fingerprint and/or swipe characteristics for the card. This information may be useful in identifying the card and/or the user, as described in greater detail elsewhere herein.

The card reader may be used to facilitate authentications. In some instances, the card may be swiped through the card reader when a user identity authentication or a financial transaction is occurring. Rather than just entering a card number or other card information on a user display of the user device, the card may be read by the card reader to retrieve the relevant information for the authentication. The relevant information may be read from the card via the card reader and used to perform the authentication. The card reader may be communicating with a user device that may be facilitating the authentication. The user device may receive the card information from the card reader and aid facilitating the authentication. The authentication may be an online authentication. The authentication may be an in-person authentication with an online component (e.g., verifying the card information, account information, or user information). The card reader may provide an additional level of security compared to entering in card information manually. An authentication read for the card may optionally be performed when the card is read by a card reader. The authentication read may result in obtaining a magnetic fingerprint and/or swipe characteristics for the card. This information may be useful in authenticating the card, the user, and/or the transaction, as described in greater detail elsewhere herein. The authentication may be permitted to be completed, may be stopped, or may cause additional verification processes to occur, based on the authentication read.

The wireless communications may include two-way wireless communications between the card reader and the user device. Data may flow from the card reader to the user device and/or data may flow from the user device to the card reader. For instance, information about a card authentication read by the card reader may be transmitted from the card reader to the user device. The user device may have a communication unit and/or the card reader may have a communication unit that may permit wireless communications between the two devices. A communication unit may optionally include an antenna. In some embodiments, a component or dongle may be plugged into the user device that may permit the wireless communication between the user device and the card reader. The component or dongle may include a communication unit that may communicate with a communication unit of the card reader.

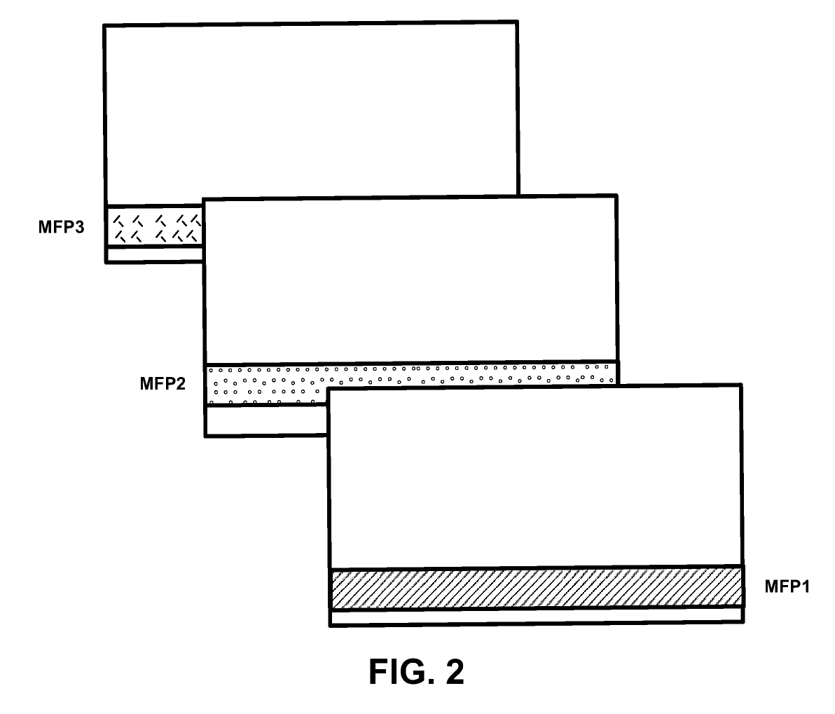

FIG. 2 shows examples of cards with corresponding magnetic strips which are used for authentications, in accordance with an embodiment of the invention. In some embodiments, the magnetic stripes of cards may be provided in accordance with one or more international or national standard. Data may be recorded in tracks on the magnetic stripe. In some examples, the magnetic stripe may be provided in a typical format of track two of an Internal Standards Organization (ISO) 7811 card. In alternative embodiments, track one or track three standards may be used. In some instances, track two (e.g., having 75 bpi) may be preferable by having a lower density than track one or track three. A track may optionally have a plurality of sections, such as LZ, SS, PAN, ES, LRC, and TZ. A wide variety of formats may be utilized in the systems and methods described herein.

The magnetic stripes may have a standardized placement on the card. The magnetic stripes may include a magnetic medium deposited or layered on a substrate of the card. The magnetic stripes may be attached to the card with aid of an adhesive. The magnetic stripes may be read with aid of a card reader (e.g., the carder reader 100 in FIG. 1).

The magnetic stripes may include magnetic transitions (e.g., north to south, or south to north). The transitions may be detected and the pattern of transitions may be useful for encoding information. The magnetic stripes may be made from individual magnetic particles. There may be inherent variations in an orientation of these magnetic particles that may account for magnetic characteristics of the stripe. These magnetic characteristics may form a magnetic fingerprint, which may be substantially unique for each magnetic stripe (e.g., magnetic fingerprint MFP1, MFP2, MFP3 for each payment card). Each magnetic stripe of each magnetic card may have a different distribution of magnetic particles, and correspondingly have different magnetic characteristics. Thus, for each magnetic stripe, a different magnetic fingerprint may be generated. This may permit magnetic stripes to be distinguished from one another.

Magnetic stripes may have data encoded therein. While an individual may read and/or duplicate the data encoded in the magnetic stripe, an individual may not be able to exactly copy the distribution of magnetic particles in the magnetic stripe. Thus, if a fraudster were to try and clone a card by copying the data encoded in a first card, onto a second card, the fraudster would still not be able to duplicate the magnetic fingerprint of the first card in the second card. The first magnetic stripe in the first card may have its own magnetic characteristics based on the distribution of individual magnetic particles, which cannot be readily duplicated in a second magnetic stripe of a second card. Thus, even if data encoded in the cards were duplicated, the magnetic fingerprints of each card based on the physical magnetic particles could not be duplicated. Thus, an individual card may be identified and/or distinguished from other cards based on the magnetic fingerprint.

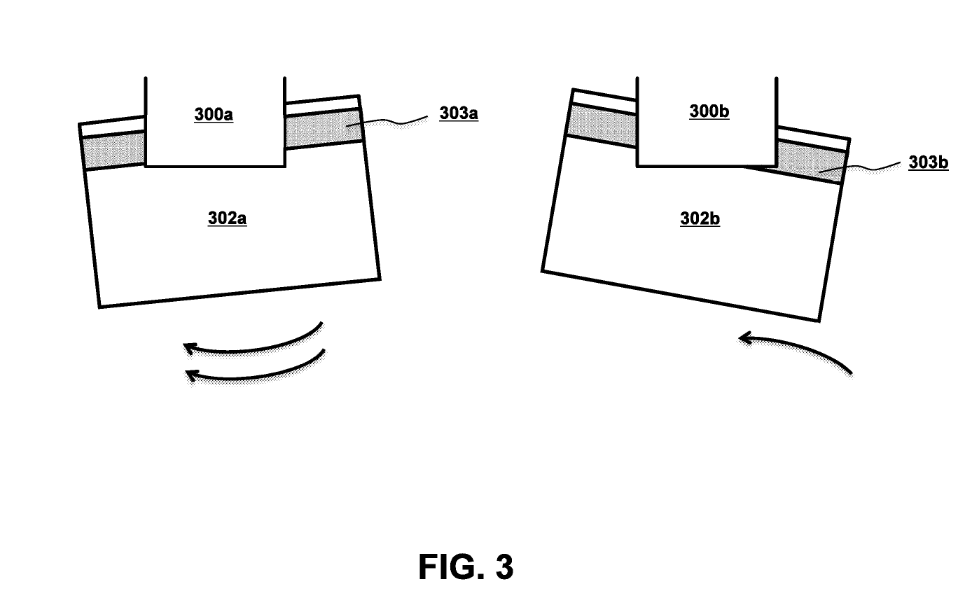

FIG. 3 shows examples of various swipe characteristics of cards used for authentications, in accordance with an embodiment of the invention. As illustrated in FIG. 3, cards 302a, 302b may be read by card readers 300a, 300b respectively. Each payment card may have a magnetic stripe (e.g., a magnetic stripe 303a, 303b) which may be read by the respective card reader. The payment cards, magnetic stripes, and/or card reader may have one or more characteristics of various embodiments described elsewhere herein.

The card reader may read the magnetic stripe to collect information when the card is swiped by or through a card reader. For example, the information may include identifying information for the card (e.g., carrier, card number, user name, etc.). An authentication read of the card may be occurring while the swipe is occurring. Alternatively, an authentication read of the card may be occurring while the card is tapped against the card reader, or while the card is present within a detectable range of the card reader. The authentication read may include collecting a magnetic fingerprint of the card and/or swipe characteristics of the card. The swipe characteristics of the card may be determined based on data collected by the card reader. The swipe characteristics of the card may be determined based on data collected using a magnetic head of the card reader.

Examples of swipe characteristics may include speed of swipe, direction of swipe, angle of swipe (e.g., swipe path), timing of swipe, and/or pressure of swipe. Different users may have a tendency to swipe cards in different manners. For example, a first user may have a tendency to swipe a card very quickly while a second user may swipe a card more slowly. In another example, first user may have a tendency to swipe a card from left to right, while a second user may have a tendency to swipe from right to left. Such swipe characteristics may be useful for identifying a user that is swiping the card. For instance, if Card A belongs to User A, who always swipes quickly and from left to right, and then a transaction is conducted using Card A where the individual swipes slowly and from right to left, it may be possible to identify that the individual is likely not User A.

The card reader may be capable of detecting a speed of a swipe. For instance, users may swipe cards at various speeds. For instance, as shown in the left scenario, the card 302a may be moving quickly as denoted by the double arrows, while in the right scenario, the card 302b may be moving more slowly, as denoted by the single arrow. The card reader may be able to distinguish speeds of card swipes on the order of tens of meters per second, meters per second, 1 meter/second, tens of centimeters per second, centimeters per second, millimeters per second, tenths of millimeters per second, hundredths of millimeters per second, or micrometers per second. For instance, if the card reader can distinguish the speed of the card swipe on the order of centimeters per second, the card reader can distinguish when a first user may swipe a card at 5 cm/s and a second user may swipe a card at 7 cm/s. The card reader may optionally measure the actual swipe speed of the card. The swipe speed may be precise on the order of tens of meters per second, meters per second, 1 meter/second, tens of centimeters per second, centimeters per second, millimeters per second, tenths of millimeters per second, hundredths of millimeters per second, or micrometers per second. For instance, a card swipe of 10.27 cm/s may be measured when the precision is on the order of tenths of millimeters per second.

The card reader may be capable of detecting a direction of a swipe. For instance, users may swipe in various directions. For instance, if the card reader includes a groove that is horizontally oriented, a user may swipe from the left to the right, or from the right to the left. If the card reader includes a groove that is vertically oriented, a user may swipe from up to down, or from down to up. Regardless of whether the card reader has a groove or any other region that reads a magnetic stripe of a card, the user may be capable of swiping the card in a first direction, or in a second direction substantially opposing the first direction. The card reader may be able to detect which direction the card was swiped.

The card reader may be able to detect angle of swipe (e.g., swipe path). For example, the card may be tilted relative to the card reader or may be parallel relative to the card reader. For instance, as shown in the left scenario, a card 302a may be angled so that the leading edge in a swipe is angled away from the card reader, while the trailing edge in a swipe is angled toward the card reader. The right scenario presents a situation where the card 302b may be angled so that the leading edge is angled toward the card reader while the trailing edge may be angled away from the card reader. In some scenarios, the card may be parallel relative to the card reader so that the leading edge and the trailing edge are identically angled relative to the card reader. The card reader may be capable of detecting an angle of swipe or an angle of a position of a card relative to a card reader on the order of multiple degrees, single degrees, tenths of degrees, hundredths of degrees or thousandths of degrees. For instance, a card may be tilted a greater than, less than, or equal to, about 45 degrees, 40 degrees, 35 degrees, 30 degrees, 25 degrees, 20 degrees, 15 degrees, 10 degrees, 5 degrees, 4 degrees, 3 degrees, 2 degrees, 1 degree, 0.5 degrees, 0.1 degrees or 0 degrees relative to the card reader. An angle of the card relative to the card reader may remain the same throughout the swipe or may be variable throughout the swipe. The angle at each point in the swipe may optionally be measured.

The swipe path of the card may be measured. This may include the curvature, angle, and/or distance of how the card is swiped relative to the card reader. For instance, as illustrated in the left scenario, the swipe path may be curved so that the inner part of the curve is facing toward the card reader 300a. The right scenario illustrates a swipe path that may be curved so that the inner part of the curve is facing away from the card reader 300b. In some instances, the swipe path may be straight without having any curvature. The degree of curvature of the path may be measured. The changes in curvature value over the swipe path may be measured. Any details of the swipe path itself, e.g., the position and/or orientation of the card relative to the card reader at any point in time of the swipe may be detected by the card reader and/or recorded.

A position of a card relative to the card reader may be detected. For example, some users may press a card deep within a groove when swiping the card so that the magnetic stripe of the card is as deep within the groove as possible. Other users may not press so deeply so that there may be some space between the card and the deepest part of the groove. This may affect the placement of the magnetic stripe relative to a magnetic sensor. In some instances, the lateral displacement (e.g., depending on how deep the card is within the groove, lateral being perpendicular to the main direction of swipe) of the magnetic stripe relative to the magnetic sensor over time may be determined.

A card reader may be capable of detecting timing of swipe. The timing of the swipe may relative to the total time it takes to swipe a card. The timing of the swipe may be related to the velocity of the swipe. The timing of the swipe may also relate to the timing of each component of a swipe path. The positions/orientations of the card may be sampled continuously. In some instances, the positions/orientations of the card may be sampled at regular or irregular time intervals. The time intervals may be on the order of every 10 seconds, 5 seconds, 3 seconds, 2 seconds, 1 second, 0.8 seconds, 0.5 seconds, 0.3 seconds, 0.2 seconds, 0.1 seconds, 0.08 seconds, 0.05 seconds, 0.03 seconds, 0.01 seconds, 0.008 seconds, 0.005 seconds, 0.003 seconds, or 0.001 seconds, or less. Such sampling frequency may be greater than, less than, or equal to any of the values described. The sampling frequency may be preset or may be variable. A user may be able to predetermine the sampling frequency. A sampling frequency may be altered based on a detected magnetic stripe based on the characteristics of the magnetic stripe.

A card reader may be able to detect pressure of swipe. For example, the card reader may be able to detect whether the magnetic stripe is rubbing hard against the magnetic sensor of the card reader or whether it is pressed more lightly against the magnetic sensor. In some instances, a gap may be provided between the card and the magnetic sensor. In some instances, the size of the gap may be measured and/or distinguished by the card reader.

One, two, three, or more swipe characteristics may be detected using the card reader. When multiple swipe characteristics are considered in combination, one or more of the swipe characteristics may be equally or unequally weighted. For example, some swipe characteristics may have a greater variability, even if the same user performs the swipe, relative to other swipe characteristics. The swipe characteristics that may have a lower weight than a swipe characteristic that tends to have lower variability. In some instances, thresholds of comparisons may be provided. The swipe characteristics that have a greater variability may have a lower threshold than a swipe characteristic that has a lower variability. Thus, a set of user swipe characteristics may be analyzed.

Thus, a user may be identified and/or distinguished from other users based on the swipe characteristics. This may be independent of whether the card that is being swiped is identified as being a particular card, or authorized as being a particular card. The user may be identified based on swipe characteristics independent of whether the card itself is flagged from fraud. In some instances, a card may be identified as the original card, but the user may be flagged as potentially not being an authorized user based on the swipe characteristics.

In some embodiments, the collected swipe characteristics may need to be completely identical to the previously stored set(s) of swipe characteristics to be considered a match (e.g. 100% match). In some instances, a perfect 100% match may be suspicious. For instance, each time a user swipes a card, there is likely to be some minor variation. Physically it is extremely unlikely that an individual swipe a card with exactly the same swipe characteristics. Having the exact same characteristics may be an indicator of a type of replay attack. For instance, a previous swipe could have been recorded, including the magnetic fingerprint and the swipe characteristics, and the previously recorded swipe may be played back as if it were occurring in real time.

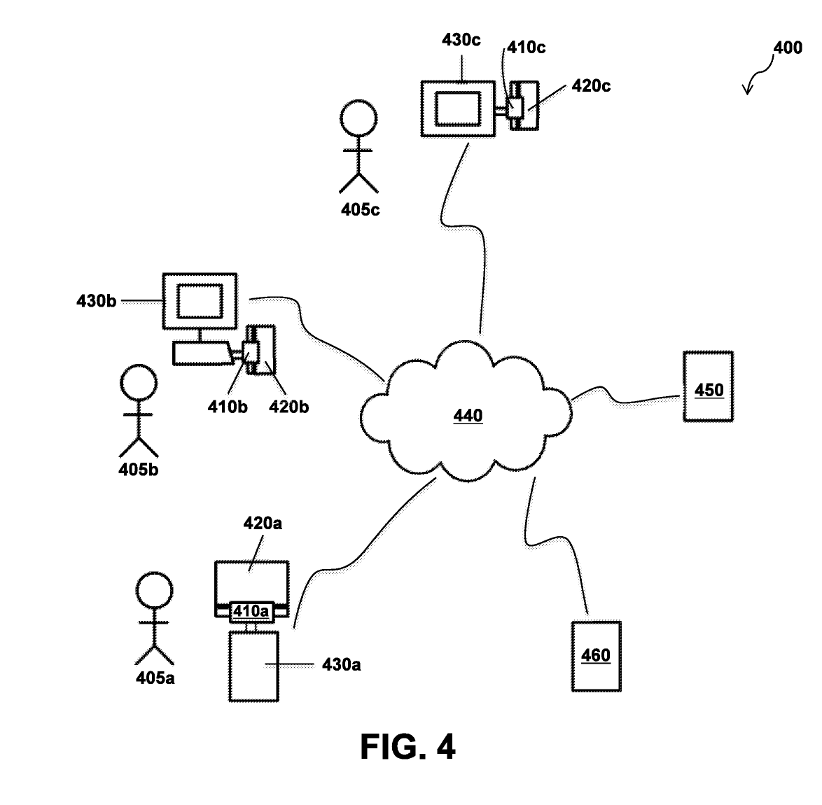

FIG. 4 shows a schematic authentication system 400 illustrating various authentications, in accordance with an embodiment of the invention. Authentications may be performed for various transactions that may or may not include the exchange of money and/or goods or services. Transactions may or may not include the exchange of information. Authentications may include any situation where a user may swipe a card. An authentication may include verification of a user's card and/or a user's identity. An authentication may relate to whenever an authentication read of a card may occur.

In some embodiments, the authentication system 400 may include one or more user devices 430a, 430b, 430c associated with respective users 405a, 405b, 405c, one or more card readers 410a, 410b, 410c in communication with respective user devices, an authentication server system 450 (e.g., a server system configured to provide secure authentication), one or more third-party entities 460 (e.g., a merchant's system, a broker's system, or other entity requiring card or identity authentications), and communication network(s) 440 for providing communications between these components.

The communication network(s) may include local area networks (LAN) or wide area networks (WAN), such as the Internet. The communication network(s) may comprise telecommunication network(s) including transmitters, receivers, and various communication channels (e.g., routers) for routing messages in-between. The communication network(s) may be implemented using any known network protocol, including various wired or wireless protocols, such as Ethernet, Universal Serial Bus (USB), FIREWIRE, Global System for Mobile Communications (GSM), Enhanced Data GSM Environment (EDGE), code division multiple access (CDMA), time division multiple access (TDMA), Bluetooth, Wi-Fi, voice over Internet Protocol (VoIP), Wi-MAX, or any other suitable communication protocols.

The user devices 430a, 430b, 430c may include one or more characteristics of the various embodiments of the user devices described elsewhere herein. In some embodiments, a user device 430a, 430b, 430c may include one or more processors configured to handle various requests from the user, the card reader, the server system 450, and/or the third-party entity 460. The user device may also include or have access to one or more databases for storing various information including but not limited to, authentication information, card information (e.g., encoded data, magnetic fingerprint data, and/or swipe characteristics) of one or more cards of the user associated with the user device, account information of the user associated with the user device, device information of the user device, device identifier of card reader(s) which may have interactions with the user device, historic authentication data, and/or usage data associated with the user of the user device (e.g., other activity data associated with the user). Various types of user devices may be used to facilitate an authentication. An authentication system may include multiple types of user devices that may be used simultaneously.

The card readers 410a, 410b, 410c may include one or more characteristics of the various embodiments of the card readers described elsewhere herein. A card reader 410a, 410b, 410c may include one or more processors configured to handle various requests. For example, the user may send a request for performing an authentication read by pressing a button or touching an icon on the card reader. The card reader may be in communication with and capable of handling requests from a user device, the server system 450, and/or the third-party entity 460. The card reader may also include or have access to one or more databases for storing various information including but not limited to, card information (e.g., encoded data, magnetic fingerprint data, and/or swipe characteristics) of one or more cards of the user associated with the card reader, account information of the user associated with the card reader, device information of the user device(s) which may have interactions with the card reader, device identifier of the card reader, historic authentication data using the card reader, and/or usage data of the user associated with the card reader.

Users 405a, 405b, 405c may use respective cards 420a, 420b, 420c to perform various authentications. The cards may aid in the transfer of funds and/or may aid in identifying or authenticating a user. Each card may include a magnetic stripe which is encoded with card information, magnetic fingerprint data, and/or account information of the card holder. The magnetic stripe may be used to determine magnetic fingerprint data which is unique to the corresponding card. The cards 420a, 420b, 420c and the associated magnetic stripes may include one or more characteristics of the various embodiments of the cards and the magnetic stripes described elsewhere herein. The card reader can connect with or communicate with various types of user devices. The various types of user devices may include, but are not limited to, a handheld device, a wearable device, a mobile device, a tablet device, a laptop device, a desktop device, a computing device, a telecommunication device, a media player, a navigation device, a game console, a television, a remote control, or a combination of any two or more of these data processing devices or other data processing devices. The card reader may connect with the user devices wirelessly or using wired connections. In some instances, a single card reader may be in communication with a single user device or multiple user devices simultaneously. In some instances, a single user device may be in communication with a single card reader or multiple card readers simultaneously.

An authentication server system 450 may include one or more processors. The authentication server system may include or have access to one or more databases. The authentication server system may be in communication with one or more user devices 430a, 430b, 430c and/or one or more card readers 410a, 410b, 410c. The authentication server system may be in communication with various user devices and/or card readers with aid of a communication unit (e.g., an I/O interface). The authentication server system may be in communication with various external server systems (e.g., merchant's system, broker's system, credit card companies, social network platforms, and/or other entities). The authentication server system may be in communication with various external server systems with aid of one or more I/O interfaces. The I/O interface to the user devices and/or the card readers may facilitate the processing of input and output associated with the user devices and/or the card readers respectively. For example, the I/O interface may facilitate the processing of a user input associated with a request for secure authentication. The I/O interface to external server systems may facilitate communications with one or more third-party entities (e.g., merchant's system, broker's system, credit card companies, social network platforms, and/or other entities).

Communications in authentication system 400 can be directed between the authentication server system (e.g., the authentication server system 450) and one or more user devices (e.g., the user devices 430a, 430b, 430c). In some instances, communications can also be directed between the authentication server system (e.g., the authentication server system 450) and the one or more card readers (e.g., the card readers 410a, 410b, 410c). Alternatively, communications between the authentication server system (e.g., the authentication server system 450) and the card readers (e.g., the card readers 410a, 410b, 410c) can only be conducted through the corresponding user devices (e.g., the user devices 430a, 430b, 430c).

The authentication server system may comprise memory storage units which may comprise non-transitory computer readable medium comprising code, logic, or instructions for performing one or more steps. The one or more processors of the authentication server system may be capable of executing one or more steps, for instance in accordance with the non-transitory computer readable media. In some embodiments, the one or more processors may generate or receive requests for performing secure authentications, processing the requests, identifying information needed for the authentications, performing the authentications, and returning the authentication results in response to the requests. The one or more databases may store various information, including but not limited to, card information of one or more cards associated with each user, account information associated with each user, device information of the user device (e.g., a user device identifier), and/or the card reader (e.g., a card reader identifier), historic authentication data, and/or usage data associated with each user (e.g., activity data associated with each user).

The card information of a card may include a card type (e.g., credit card, membership card, identity card, etc.), a card issuer (e.g., a credit carrier, a company, the government, etc.), a credit carrier type (e.g., Visa, Mastercard, American Express, Discover, etc.), a card number, a card expiration date, and/or a card security code. The account information may include user's name, user's mailing address, user's telephone number, user's email address, user's birthdate, user's gender, user's social security number, user account ID and associated password, or any other personal information about the user. In some embodiments, the card information also includes magnetic fingerprint data and swipe characteristics of a card associated with each user.

The card information, the account information, and/or the device information may be obtained and stored in the databases of the authentication server system 450 during various authentication activities of the user. The authentication server system may have access to the databases or a subset of the databases for storing the card information, the account information, and/or the device information. The card information, the account information, and/or the device information may also be obtained and stored during an initial registration of the user at the authentication server system. In some embodiments, the card information, the account information, and/or the device information may only be accessible by the authentication server system. For instance, the third-party entity 460 may or may not be able to access the same databases or a subset of the same databases for storing the card information, the account information, and/or the device information.

The third-party entity 460 may be implemented on one or more standalone data processing apparatuses or a distributed network of computers. In some embodiments, the entity 460 may also employ various virtual devices and/or services of third party service providers (e.g., third-party cloud service providers) to provide the underlying computing resources and/or infrastructure resources. In some embodiments, upon user's approval and in pursuance to related privacy policies, the third-party transaction entity may or may not store card information, account information, usage data, and/or device information associated with the user. One or more third-party transaction entities may comprise e-commerce systems, retail systems, financial institutions (e.g., banks, brokers, and credit card companies), merchant's systems, social networking platforms, and/or other entities which the user performs authentications with. In some instance, the third-party entity may be an online e-commerce, and a user may perform an authentication read of a credit card to complete a purchase of a product online. In some instance, the third-party entity may be a broker system, and a user may perform an authentication read of a card for verifying transfers of funds between the user's financial account and the broker system. In some instance, the third-party entity may be a social networking platform which hosts a plurality of user accounts. A user may use the authentication read of a card for verifying user's login to the social networking platform.

Communications in transaction system 400 can be directed between the third-party entity (e.g., the third-party entity 460) and one or more user devices (e.g., the user devices 430a, 430b, 430c). In some instances, communications can also be directed between the third-party entity (e.g., the third-party transaction entity 460) and the one or more card readers (e.g., the card readers 410a, 410b, 410c). Alternatively, communications between the third-party entity (e.g., the third-party transaction entity 460) and the card readers (e.g., the card readers 410a, 410b, 410c) can only be conducted through the corresponding user devices (e.g., the user devices 430a, 430b, 430c).

Steps for performing secure authentications may be implemented according to various embodiments. Requests for authentication reads may be initiated at user side. In some embodiments, a user may initiate a request for a secure authentication read to complete a transaction. For example, during a transaction or a login process, the user may send a user input (e.g., by pressing a button or touching a touch screen of a user device or a card reader) to indicate the user's intention to initiate a secure authentication for the transaction or the login process. In some embodiments, requests for secure authentication reads may be initiated from a user device or a card reader. In some instances, a request for a secure authentication read may be initiated from an authentication server system. In some instances, a request for a secure authentication read may be initiated from a third-party entity.

During initial registration of a user account with an authentication server system, the user may register for relevant account settings to require secure authentication reads for activities associated with this user account. During the following activities, the authentication server system may recognize a request for a transaction or a login process associated with the user account. In response to the request for the transaction, the authentication server system may send a request for a secure authentication to complete the transaction or the login process. During registration and/or the following account activities, the user may register to require authentication reads for all activities or some activities with certain conditions.

During initial registration of a user account with a third-party entity, the user may register for relevant account settings to require secure authentication reads for activities associated with this user account. For example, during initial setup of a user account to activate or manage a card on a bank's website or within the bank's application, the user may select to perform secure authentications for one or more transactions. During the following transactions, once the third-party transaction entity recognizes a transaction associated with the user account is requested, a secure authentication is required to complete this transaction using the card. During registration and/or the following account activities, the user may register to require authentication reads for all activities or some activities with certain conditions.

The secure authentications may be required or provided as an option by an authentication server system for one or more activities. In some embodiments, the secure authentications may be required by a third-party entity. For example, a bank system or a broker system may require secure authentications to be performed to complete all or certain transactions (e.g., flagged transactions, transactions above a predetermined limit amount, or randomly selected transactions). In some instances, a secure authentication may be optional, but the third-party entity may offer rewards (e.g., cashback or bonus reward points) to the user if the user chooses to perform a secure authentication to complete the transaction.

The secure authentications may be required for all activities or some activities associated with the user account. For example, a secure authentication may be required when a transaction involves an amount of money equal to or greater than a predetermined threshold amount. For example, the predetermined threshold amount may be $100, $200, $500, $1000, $5000, $8000, $10,000, $15,000, $20,000. The threshold amount may be determined by the user, an authentication server system, or a third-party entity. In some embodiments, secure authentications may be required when the activities are identified as high risk activities. For example, the high risk activities may involve suspicious/mismatched user identity associated with the user account, suspicious transaction locations, repetitive entering of wrong user information, and/or flagged user account for previously associated fraudulent activates. In some embodiments, high risk activities may involve high speed transactions, such as requiring for funds to be transferred within a short period of time. When high speed transactions are identified, further security checks, such as authentication reads, may be required from the user. In some instances, the use of the further authentication may allow for online activities to occur in situations where previously in-person activity was required. The further assurances of a user's identity may aid in giving entities comfort in permitting larger scale transactions.

As illustrated in FIG. 4, a user may use a card to perform an authentication for a transaction of exchanging money, goods, and/or services with a third-party entity. For example, the user may purchase an item online from the third-party entity (e.g., an e-commerce) using a user device (e.g., a tablet or a mobile phone). The user may perform the authentication on a website or in an application associated with the third-party entity.

After selecting the desired item to purchase and entering required information for the transaction (e.g., desired quantity of the item and relevant user information), the user may be prompted to perform a secure authentication. For example, when the user wants to purchase an item priced at $1000, the user may receive a notification on the display of the user device which requires the secure authentication. The notification may require the user to couple a card reader with the user device, and then swipe a card through the card reader. The card may include, by is not limited to, a payment card, (e.g., a credit card), an identity card, or a membership card,

Alternatively, the user may log into a registered user account on a website or in an application, such as a public service, an online voting system, a social networking service, etc. The user may receive a notification during the login process to perform the secure authentication as an identity verification. The notification may require the user to swipe a card (e.g., an identity card, a credit card, a membership card, etc.) through the card reader to perform the secure authentication.

In some embodiments, the third-party entity may generate the request to perform the secure authentication per requirement of the third-party entity or per user accounting settings registered with the third-party entity. The third-party transaction entity may send the request to the user device for display.

In some alternative embodiments, the user may indicate the intention to perform the secure authentication via a user input on the user device. For example, the user may click an icon on the display or press a button on the user device to request for the secure authentication. The user may also connect the card reader with the user device and a request for the secure authentication may be displayed on the user device.

As the user swipes the card through the card reader, a sensing unit of the card reader may collect various information associated with the card. For example, as the user swipes the card, the sensing unit may be configured to detect the magnetic stripe and obtain the data encoded in the magnetic stripe and/or magnetic fingerprint data of the stripe. The sensing unit of the card reader may also obtain one or more swipe characteristics (e.g., speed of swipe, direction of swipe, angle of swipe (or swipe path), timing of swipe, and/or pressure of swipe as discussed herein). After collecting the information associated with the card, the card reader may send the collected information to the user device, or directly to an authentication server system or the third-party entity.

The user device may obtain the card reader identifier of the card reader when a communication is established between the card reader and the user device either wirelessly or via a wired connection. The card reader may also transmit the card reader identifier to the user device at any stage of the secure authentication.

After receiving the card information (e.g., magnetic fingerprint of the card), swipe characteristics, and/or the card reader identifier from the card reader, the user device may determine whether to approve or reject the authentication. For example, the user device may compare information received from the card reader and information associated with the current authentication with historic authentication data stored in the databases of the user device or accessible by the user device. For example, the user device may compare the collected magnetic fingerprint with magnetic fingerprints that allegedly come from the card. The user device may compare the collected swipe characteristics with swipe characteristics that allegedly come from the user swiping the card in previous authentications or during a registration of the card. The user device may compare the received card reader identifier with card reader identifier that allegedly comes from previous authentications using card reader or during a registration of the card reader. In some instances, the collected data may be compared with data collected from a predetermined number of most recent authentications.

Additional information may be used to identify the corresponding data from historic authentications for comparison. For example, during the authentication read, the card reader may collect data encoded in a magnetic stripe. The encoded data may include identifying information for the card, such as card number and/or carrier. The encoded data may be used to identify the allegedly same card. For example, the user account information provided by the user during the current authentication may be used to identify previous swipe characteristics associated with the user using the card.

The user device may compare information received from the card reader and information associated with the current authentication with any or all of the previously collected information that is registered to belong to the identified card or the identified user account. For example, the previously collected information may be collected during a user account registration process and stored in the databases of or accessible to the user device. For instance, if a registration fingerprint is registered to be associated with the identified card, the collected magnetic fingerprint may be compared with the registration fingerprint. Similarly, the user device may compare the collected swipe characteristics and/or card reader identifier of the current authentication with the corresponding registration data stored in the user device or accessible to the user device.

When one or more types of data received from the card reader does not match the corresponding data from historic authentications or registrations, the authentication is rejected. For example, when the collected magnetic fingerprint data, swipe characteristics, card reader identifier and/or user device identifier does not match the corresponding historic authentication or registration data, the authentication is rejected. An alert may be displayed to the user. Additional verification may be required from the user to proceed with the authentication. A flag notification may be sent to the third-party entity to flag and/or reject the authentication. The approval or rejection criteria may be predetermined by the user account settings, the third-party entity, and/or the authentication server system.

As illustrated in another embodiment in FIG. 4, a user may use a card to perform an authentication for a transaction of exchanging money, goods, and/or services with a third-party entity. For example, the user may use a user device (e.g., a desktop computer) to transfer an amount of money online to the third-party entity (e.g., a broker system). The third-party entity may send a request to perform a secure authentication to the user device. For example, the third-party entity may offer rewards (e.g., cashback or rewards points) to the user if the user chooses to perform the secure authentication. Alternatively, the user may send a request via a user input on the user device to initiate the secure authentication. Alternatively, the user may connect the card reader with the user device, and by detecting a communication being established between the card reader and the user device, a notification is displayed on the user device to request the secure authentication from the user.

As the user swipes a card through the card reader, a sensing unit of the card reader may collect the data encoded in the magnetic stripe, magnetic fingerprint data of the card, and/or swipe characteristics. In addition, user device information (e.g., user device identifier) may be transmitted to the card reader for verification. The card reader may determine whether to approve or reject the authentication based on the collected information. For example, the card reader may compare collected information with the corresponding data obtained from previous authentications and/or registrations and stored in the databases of the card reader. The card reader may send a message to the user device to approve, reject, or flag an authentication based on the comparison result.

As illustrated in a further embodiment in FIG. 4, a user may use the card to perform an authentication for a login process to an online service. For example, the user may be trying to use a user device (e.g., a mobile phone or tablet) to log into a preregistered user account with the authentication server system or the third-party entity.

During the login process, a secure authentication read may be required by the authentication server system, the third-party entity, or the user. In response to the request, the user may swipe a card through the card reader. Card information including magnetic fingerprint data, swipe characteristics, and/or the card reader identifier can be obtained and transmitted from the card reader to the authentication server system and/or the third-party entity directly or indirectly through the user device. The user device information (e.g., user device identifier) may also be transmitted to the authentication server system and/or the third-party entity for verification.

The authentication server system may store or have access to various historic authentication information or registration information that can be used for authentication read. The information may include but is not limited to, user account information, card information (e.g., card number and/or magnetic fingerprint), swipe characteristics of the user, user device identifier, and/or card reader identifier. The third-party entity may also store or have access to various historic authentication information or registration information that can be used for authentication read, such as user account information, card information (e.g., card number and magnetic fingerprint), swipe characteristics, user device identifier, and/or the card reader identifier.

The authentication read may be performed by the authentication server system solely or the third-party entity solely. In some instances, the authentication read may be performed by both systems in a combined manner. For example, some information may be verified at the third-party transaction entity, such as user account information, user device identifier, and card reader identifier. Meanwhile, other information may be verified at the authentication server system, such as card information and swipe characteristics.

In some instances, the third-party entity may store or have access to only user account information without having access to other confidential and/or financial information of a user, such as card information, swipe characteristics of the user, and/or card reader identifier. Thus when an authentication with the third-party entity requires an authentication read, the third-party entity may designate the authentication server system to perform an authentication read. The authentication server system may then perform the authentication read and return a message to the third-party transaction entity indicating whether the authentication read is approved or not. The transaction may then be approved or rejected accordingly by the third-party entity.

In some embodiments, the authentication server system may be optional in the authentication system 400. Separate third-party entities may perform any step or all steps of the authentication read.

In some embodiments, the authentication server system can simultaneously perform authentication reads for multiple authentications for different activities. The authentication server system may simultaneously perform authentication reads for multiple separate third-party entities. Information stored at or accessible to the authentication server system can be collected over multiple transactions associated with various third-party entities. The authentication server system may have access to data repository that the third-party entities individually may not have access to.

The authentication server system and/or the third-party entity may analyze the received information, and compare the received information with the corresponding information obtained from historic authentications and/or registrations. The user login or transaction may be approved, rejected, or flagged as a risk authentication/login based on the comparison result. The user may be notified by the authentication server system or the third-party entity once the login or authentication is approved, rejected, or flagged.

Various embodiments may exist for evaluating the match between the collected data and historic authentication data or registration data. In some examples, when the collected data from the card reader matches the corresponding historic authentication data or registration data, a message may be sent to the third-party transaction entity to approve the authentication. In some examples, one or more conditions of the collected magnetic fingerprint, swipe characteristics, and card reader identifier of the current authentication may respectively match the historic authentication data or registration data, the authentication can be approved.

For instance, the collected swipe characteristics may need to be completely identical to the previously stored set(s) of swipe characteristics to be considered a match (e.g. 100% match). In in some instances, a perfect 100% match may be suspicious. For instance, each time a user swipes a card, there is likely to be some minor variation. Physically it is extremely unlikely that an individual swipe a card with exactly the same swipe characteristics. Having the exact same characteristics may be an indicator of a type of replay attack.

Alternatively, there may be some leeway in how closely the swipe characteristics match. If the level of match exceeds a predetermined threshold, then the swipe characteristics may be considered a match. For example, if the swipe characteristics match by more than 70%, 75%, 80%, 85%, 90%, 95%, 97%, 99%, 99.9%, 99.99%, then the swipe characteristics may be considered a match. In some instances a ‘sweet spot’ of matching may be provided, where the swipe characteristics may exceed a particular threshold, but may be beneath an identical match that may be considered suspicious. For instance, to constitute a proper match, the swipe characteristics may be less than or equal to about 100%, 99.999%, 99.99%, 99.9%, 99%, 98%, 97%, 95% or 90%. To constitute a match, the swipe characteristics may have a value greater than any of the lower values described herein, and simultaneously a value less than any of the higher values described herein. For instance, to qualify as a match, the swipe characteristics may have an overall value (e.g., weighted value of multiple swipe characteristics, or a value of a single swipe characteristic), of greater than 80% while being less than 99.99%.

In some embodiments, the collected magnetic fingerprint may need to be completely identical to the previously stored magnetic fingerprint(s) to be considered a match (e.g. 100% match). Alternatively, there may be some leeway in how closely the magnetic fingerprints match. If the level of match exceeds a predetermined threshold, then the magnetic fingerprints may be considered a match. For example, if the fingerprints match by more than 70%, 75%, 80%, 85%, 90%, 95%, 97%, 99%, 99.9%, 99.99%, then the fingerprints may be considered a match.

In some embodiments, a magnetic fingerprint of a card may change over time. For instance, the magnetic stripe may become slightly demagnetized. Scratches or other wear may affect the magnetic stripe. Such natural adjustments to the magnetic stripe may affect the magnetic fingerprint. In some instances, the leeway in how closely the magnetic fingerprints match may permit some natural change in the magnetic fingerprint over time as the magnetic stripe undergoes regular use. However, if a drastic change were to occur, it may fall outside the leeway range, and may be flagged as a potentially different card.

The comparison of the magnetic fingerprint may be relative to an original registration fingerprint. The threshold may allow from some variability from the original swipe, but may not allow the card to deviate too greatly from the original swipe. In another example, the comparison of the magnetic fingerprint may be relative to a single most recent or multiple most recent fingerprints. The threshold may allow for some change relative to the previous swipe(s), and may be more accommodating of evolution over time. For instance, the magnetic fingerprint may change gradually from swipe to swipe over time, and over a great length of time, may deviate more significantly from an original registration fingerprint as opposed to a more recent fingerprint. In some instances, multiple thresholds may be provided. For instance, a lower threshold may be provided when comparing the magnetic fingerprint with an original registration fingerprint (e.g., requiring at least 80% match) while a higher threshold may be provided when comparing the magnetic fingerprint with a recently fingerprint (e.g., requiring at least a 99% match with the most recent fingerprint). The magnetic fingerprint may be compared with an average of one or more of the earlier fingerprints. In some instances, the magnetic fingerprint may be compared with an average of all of the previous fingerprints.

As previously described, an indication of fraud may provide an indication of a level of fraud risk. The level of fraud risk may optionally depend on the level of match of the magnetic fingerprints. For instance, if the magnetic fingerprints are a 100% match, the level of fraud risk may be none, or very low. If the magnetic fingerprints are a 70% match, the level of fraud risk may be moderate, and if the magnetic fingerprints are a 40% match, the level of fraud risk may be high. The level of fraud risk may be inversely proportional to how high a match the fingerprints are at. A higher match may correlate to a lower risk of fraud, a lower match may correlate to a greater risk of fraud.

In some embodiments, the comparison of the collected data and the stored data may be assigned a matching score, and when the matching score is no lower than a predetermined threshold, such as 70%, 80%, 90%, or 95% of similarity, the authentication is approved. Otherwise, when the matching score is below the predetermined threshold, the authentication is rejected. Optionally, an indication of a likelihood of fraud may be provided based on the matching score.

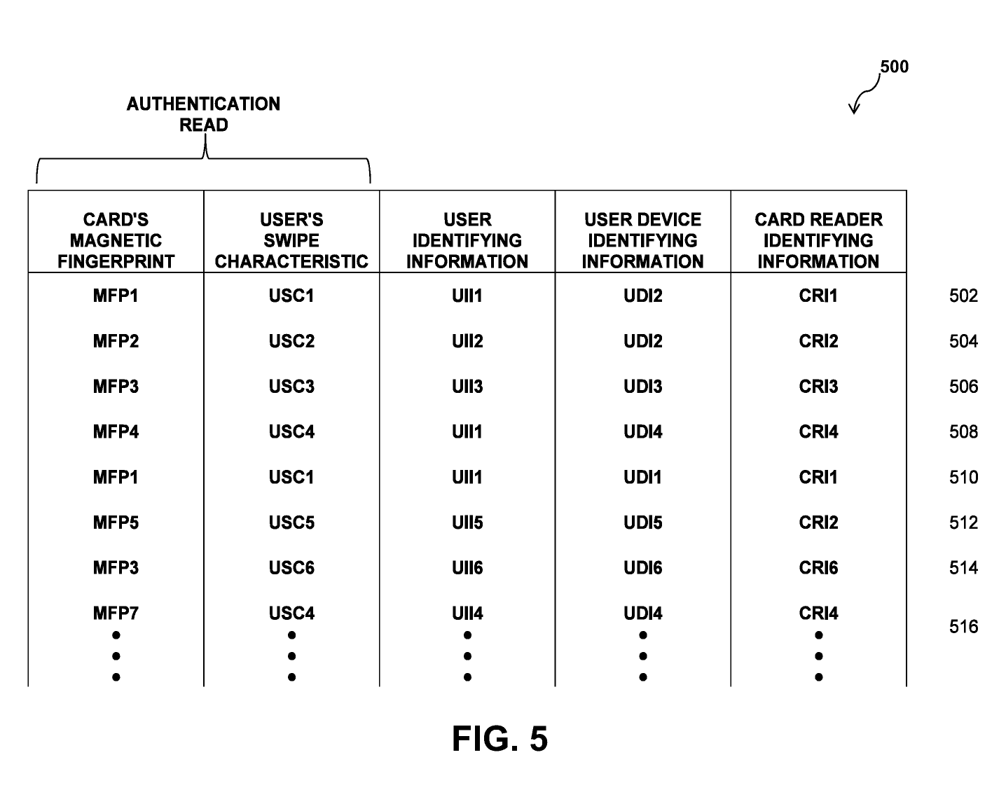

FIG. 5 shows examples of data 500 that may be stored for various authentications, in accordance with an embodiment of the invention. In some embodiments, these data may be stored in the databases of or accessible to the user device, the card reader, the authentication server system, and/or one or more third-party entity systems as discussed elsewhere herein. The authentications may be performed for transactions which may or may not include the exchange of money and/or goods or services. Transactions may include donations. Authentications may include any situation where a card reader may read a card, an identity card, a membership, or any other types of card. This may occur regardless of whether money is transferred or not. For instance, a user may swipe a user's library card to check out a book. A user may swipe an AAA® membership card to log into a user account. Alternatively, a user may swipe an insurance card to verify the user identity. An authentication may include verification of a user's card and/or a user's identity.

The data 500 may include historic data collected from one or more authentications. The historic data may all be stored together in a single memory unit or may be distributed over multiple memory units. Data distributed over multiple memory units may or may not be simultaneously accessible or linked. The historic data may include data collected for a single card, or for multiple cards. Data from multiple cards may all be stored together or may be stored separately from one another. The historic data may include data for a single user, or from multiple users. Data from multiple users may all be stored together or may be stored separately from one another. The historic data may include data collected from a single card reader or from multiple card readers. Data from multiple card readers may all be stored together or may be stored separately from one another. In some instances, a single card reader may be provided for a single user. Alternatively, multiple users may use a single card reader, or a user may use multiple card readers when swiping cards. In some embodiments, the data 500 may also be collected and stored during user account registrations.

The stored data may be from various authentications and include information such as data from an authentication read, user identifying information (UII), user device identifying information (UDI), card reader identifying information (CRI), and/or any additional information from the card. The authentication read data may include magnetic fingerprint data (MFP) of the corresponding card and user's swipe characteristics (USC) of the card associated with a user's way of swiping the card.

The authentication read may occur when a card is sensed by a sensing unit of the card reader. The authentication read may include a magnetic fingerprint for the card, and/or one or more swipe characteristics as the card was swiped. The magnetic fingerprint and/or the swipe characteristics may be used individually, or in combination, to identify and/or authenticate a card or a user. More details of the magnetic fingerprint and/or the swipe characteristics are discussed elsewhere herein. The magnetic fingerprint data for each authentication read may be stored (e.g., MFP1, MFP2, MFP3, MFP4 . . . ). The magnetic fingerprint data for each authentication read may be stored in any suitable format, such as raw data collected by the sensing unit of the card reader, or a string of numerous characters generated based on the collected magnetic data. The swipe characteristics for each authentication read may be stored (e.g., USC1, USC2, USC3, USC4 . . . ). The swipe characteristics for each authentication read may be a hash of the collected data or a string of numerous characters generated based on the collected raw data. The user device identifying information for each authentication read may be stored (e.g., UDI1, UDI2, UDI3, UDI4 . . . ). The card reader identifying information for each authentication read may be stored (e.g., CRI1, CRI2, CRI3, CRI4 . . . ).

The user identifying information may be a unique identifier that identifies a particular user account, e.g., UII1, UII2, UII3, UII4 . . . . The user identifying information for each authentication may be determined based on data encoded in the magnetic stripe. For example, the sensing unit may read the encoded data in the magnetic stripe, and a user account may be identified to be associated with the encoded data. The user identifying information may also be determined based on user's name, user's mailing address, user's telephone number, user's email address, user's birthdate, user's gender, user's social security number, user account ID and associated password, and/or any other account information about the user. The particular user account associated with the current authentication may be determined based on the encoded data read from the card or various user input during the authentication. The user identifying information may be the owner of the card, the card holder, and/or an authorized user of an account tied to the card. Alternatively, when user account ID is not available, any information associated with a user can be used for identifying the user account, such as authentication read, user device identifying information, card reader identifying information, and/or combinations thereof.

The first few authentications (e.g., the first three authentications 502, 504, and 506 listed in FIG. 5) may not raise any red flags. One or more of the first few authentications may occur during user account registrations. One or more of the first few authentications may be stored during a registration of a new user account and/or a new card after the card is activated. It is noted that the user device UDI2 are used for both authentications 502 and 504, thus it may be suggested that the user device UDI2 is a shared device between user UII1 and UII2. In some embodiments, when both users register a shared user device with the system, it may be determined to see if both users are registered with the system. If any or both of the users have not registered with the system, the corresponding authentication may raise a red flag. In some embodiments, each card reader may be associated with an individual user. If two users are sharing a user device without sharing card reader, the authentication read process may not require a one-to-one correspondence between user device identifier and the card reader identifier. The authentication read process may not require a one-to-one correspondence between user identifying information and the card reader identifier.

In some embodiments, when an authentication read occurs during a following authentication (e.g. authentication 508), the user identifying information (UII) may be determined. For instance, the data encoded on the card may be read to identify the authentication 508 is associated with UM. During the current authentication, the magnetic fingerprint data (e.g., MFP4) and/or user's swipe characteristics (e.g., USC4) are also obtained by the sensing unit of the card reader. Additionally, the user device identifying information (e.g., UDI4) and the card reader identifying information (e.g., CRI4) may also be obtained from the user device and the card reader used in the current authentication.

After collecting the information of the current authentication, the historic data may be analyzed to identify a card and/or user for the current authentication. For example, historic authentication 502 may be identified based on a match of the user identifying information UII1. However, after comparing other collected data fields of the authentication 508 with the stored data fields of the authentication 502, it is noted that the magnetic fingerprint data (MFP4 vs. MFP1), the swipe characteristics (USC4 vs. USC1), user device identifying information (UDI4 vs. UDI1), and the card reader identifier information (CRI4 vs. CRI1) of these two authentications are all different. It may be determined that the authentication 508 is a fraud using a clone card of the card associated with user account UII1. Sometimes differences of at least one, two, or three of these information may raise a red flag.

As previously discussed, the magnetic fingerprint data is unique to each card. Thus the different magnetic fingerprint data identified in authentications 502 and 508 may suggest a clone card of the card MFP1 is being used in the authentication 508. Furthermore, different swipe characteristics, different user device identifying information, and different card reader identifying information identified in authentications 502 and 508 may further suggest different users are using the same user account information UM. Thus, the authentication 508 may be flagged and/or rejected. A first alert may be sent to the corresponding authentication entity server system to reject the authentication 508, and a second alert may be sent to the user account UII1 to notify the user of this fraudulent authentication. In some embodiments, a request for further verification may be sent to the user account UII1 to request for user's manual verification of the authentication 508. Additionally, the user account associated with data such as USC4, UDI4, and/or CRI4 may be registered as a purported user.

In some embodiments, when an authentication read occurs during a transaction or a registration (e.g. authentication 510), the user identifying information (UII) may be determined. For instance, the data encoded on the card may be read to identify the authentication 510 is associated with UM. During the current transaction, the magnetic fingerprint data (e.g., MFP1) and/or user's swipe characteristics (e.g., USC1) are also obtained by the sensing unit of the card reader. Additionally, the user device identifying information (e.g., UDI1) and the card reader identifying information (e.g., CRI1) may also be obtained from the user device and the card reader used in the current authentication.

The historic data may be analyzed and the data from authentication 502 may be identified for verifying the current authentication. After comparing other collected data fields of the authentication 510 with the stored data fields of the authentication 502, it is noted that the magnetic fingerprint data (MFP1 vs. MFP1), the swipe characteristics (USC1 vs. USC1), and the card reader identifier information (CRI1 vs. CRI1) of these two authentications are all identical. This may indicate the same user UII1 is indeed using the same card with MFP1 to perform authentication 510. However, the user device identifying information (UDI1 vs. UDI2) for these two authentications appear to be distinct.

In some embodiments, it may be further identified that the user device UDI1 is registered to be owned by the user account UII1, thus it may be determined that the authentication 510 is a normal authentication without raising any flag. The user account UII1 may be registered with both the user device UDI2 and the user device UDI1, and a switch between these two user devices may not cause any problem for the secure authentication read. In some embodiments, the authentication 510 may trigger a confirmation request sent to the user account UII1 or the user device UDI1 and/or the user device UDI2 to request user input from the user UII1 for verifying the authentication 510. The transaction 510 may finally go through or be rejected based on the user's response to the confirmation request. The criteria to approve, flag, or reject a transaction may be predetermined by a server system or a user account settings.

During an authentication read occurred in authentication 512, based on the collected card reader identifying information CRI2, authentication 504 may be identified for verifying the authentication 512. However, the collected magnetic fingerprint data (MFP5), swipe characteristics (USC5), user identifying information (UII5), and user device identifying information (UDI5) are all distinct from the corresponding data stored for authentication 504, thus the authentication 512 may be rejected as the card reader CRI2 has been determined to be associated with user account UII2.

Alternatively for authentication 512, it may be determined that the card reader CRI2 is a shared device that is possibly associated with multiple user accounts (e.g., UII2 and UII5). For example, user account UII2 and UII5 may belong to the same household, thus sharing the same card reader CRI2. A request for confirmation may be sent to the user account UII2 for verification of this information. Based on the response received from the user account UII2, the authentication 512 may be determined to be approved or rejected. The criteria to reject the authentication or to request for additional verification may be predetermined by a server system or a user account settings.

Authentication 514 may raise a flag. During an authentication read occurred in authentication 514, magnetic fingerprint MFP3 may be collected and identified to belong to card associated with authentication 506. However, it is further identified that the swipe characteristics (USC6 vs. USC6), user identifying information (UII6 vs. UII3), user device identifying information (UDI6 vs. UDI3), and the card reader identifier information (CRI6 vs. CRI3) of these two authentications are all different. This may be determined to be an authentication associated with card theft. For example, user UII6 may have stolen the card with MFP3 from the user UII3, and may be trying to complete an authentication using user UII6's own user device UDI6 and card reader CRI6 with this stolen card. Thus the authentication 514 may be immediately rejected, and notifications may be sent to the related server and user account UII3 regarding this fraudulent authentication 514.

The authentication 516 may raise a flag because the collected user's swipe characteristics USC4, user device identifying information UDI4, and card reader identifying information CRI4 are identified to match those of the previously registered purported user from authentication 508. In some embodiments, when a single data field is identified to match the corresponding data field of a previously registered purported user, such as card reader identifier CRI4, the authentication 516 is flagged and rejected. In authentication 516, card with magnetic fingerprint data MFP7 and a new user identifying information UII4 are further collected. The related information (e.g., user account UII4 and card with MFP7) may be reported to the relevant entity system(s), such as card issuer and/or relevant credit bureau. Future authentications using user account UII4 and/or user's swipe characteristics USC4 may be flagged to be associated with the purported user and thus may be rejected and reported.

Other scenarios may be possible. For instance, the same card data may be provided over multiple authentications. The swipe characteristics over the multiple authentications may match, but the magnetic fingerprints may change. This may indicate that the same user is swiping a clone or copy of a previous card. This may raise a red flag if the user is making copies of his or her card.

Such scenarios are provided by way of example only. As discussed above, a magnetic fingerprint may be compared with one or more previously stored magnetic fingerprints to identify a card. Swipe characteristics may be compared with one or more previously stored swipe characteristics to identify a user. The magnetic fingerprint and the swipe characteristics may be analyzed in conjunction. This may provide greater clarity as to possible issues or scenarios that are arising. For instance, different scenarios may be presented (1) if both the magnetic fingerprint and the swipe characteristics do not match, (2) the magnetic fingerprint matches but the swipe characteristics do not match, (3) the magnetic fingerprints do not match but the swipe characteristics match, or (4) both the magnetic fingerprint and the swipe characteristics match. The degree or level of matching of the magnetic fingerprint and/or swipe characteristics may be further considered in the analysis. This may also be considered in conjunction with card data.

Possible fraudulent scenarios may be detected. Some examples of outcomes may include, but are not limited to, a fraudulent user who has copied/skimmed another user's card and is swiping the skimmed card to pass as the original user's card (e.g., when both magnetic fingerprint and swipe characteristics do not match), a fraudulent user who is replaying pre-recorded data (e.g., when the magnetic fingerprint matches and the swipe characteristics are not considered to match because they are too identical—e.g., 100% match for all characteristics), a fraudulent user who has stolen another user's physical card and is trying to pass as that victim user (e.g., when the magnetic fingerprint matches and the swipe characteristics are not a match because they are too different), a user who has copied or skimmed his own card and is swiping the copied card (e.g., when the magnetic fingerprints do not match and the swipe characteristics do match), or when both the card and the user are identified/authenticated as who they are purporting to be (e.g., when the magnetic fingerprint and the swipe characteristics both match).

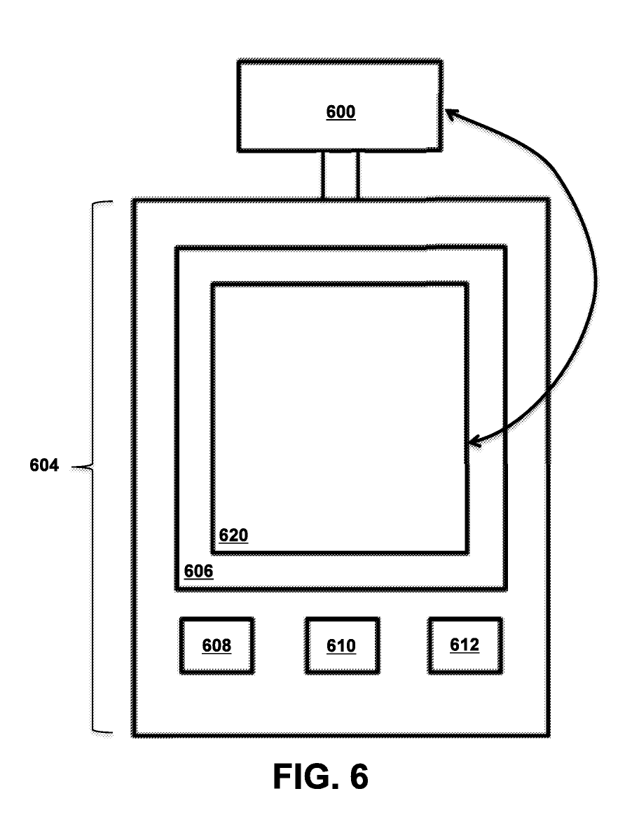

FIG. 6 shows an example of a user device 604 used for verifying various authentications, in accordance with an embodiment of the invention. In some embodiments, the user device 604 may be in network communication with a card reader 600 using a wired connection or wirelessly. The user device 604 may have one or more characteristics of the various embodiments of the user device described elsewhere herein.

Examples of the user device may include, but are not limited to, a handheld computer, a wearable computing device, a personal digital assistant (PDA), a tablet computer, a laptop computer, a desktop computer, a cellular telephone, a smart phone, an enhanced general packet radio serves (EGPRS) mobile phone, a media player, a navigation device, a game console, a television, a remote control, or a combination of any two or more of these data processing devices or other data processing devices.

The user device 604 may include one or more processors 608, memory 610, one or more network interfaces 612, and one or more communication buses (not shown) for interconnecting these components (e.g., a chipset). The user device 604 may also include a user interface 606. The user interface 606 may include one or more output devices that enable presentation of media content, such as one or more visual displays and/or one or more speakers.

The user interface 606 may also include one or more input devices for facilitating user input, such as a touch screen display, a touch-sensitive input pad, a camera, a gesture capturing camera, a microphone, a keyboard, or other input buttons or controls. One or more applications (e.g., a mobile application or a browser-run application 620) may run on the user device 604 and displayed on the user interface 606.

The memory 610 may include high-speed random access memory, such as DRAM, SRAM, DDR RAM, or other random access solid state memory devices. The memory 610 may optionally include non-volatile memory, such as one or more magnetic disk storage devices, one or more optical disk storage devices, one or more flash memory devices, or one or more other non-volatile solid state storage devices. The memory 610 may include one or more storage devices remotely located from one or more processors 608. The memory 610 may include a non-transitory computer readable storage medium which stores various programs, modules, and data structures related to the operating system, network communication modules, display modules, request handling modules, and/or data processing modules. The memory 610 may also include databases for storing various information including but not limited to, authentication data, card information (e.g., encoded data, magnetic fingerprint data, and/or swipe characteristics) of one or more cards of the user associated with the user device, account information of the user associated with the user device, device information of the user device, device identifier of card reader(s) which may have interactions with the user device, historic authentication data, and/or usage data associated with the user of the user device (e.g., other activity data associated with the user).

In some embodiments, a mobile application may be run on the user device for performing the secure authentications. For example, the mobile application may be associated with an authentication server system, as described in any of the embodiments provided herein. The mobile application may be distributed by the authentication system and/or may be operated or maintained using the authentication system. During an authentication, the mobile application may be prompted to open on the user device. A notification may be displayed within the application to request for a secure authentication. After the card is swiped through the card reader 600, the collected data may be displayed and verified by comparing with the historic authentication data. The mobile application may facilitate the operation of a card reader in communication with the user device. The mobile application may allow the collection and/or transmission of data using the card reader. The mobile application may be able to detect a card reader identity and/or user device identity.

In some embodiments without switching the user interface, the secure authentication can be performed within the same user interface for performing the authentication. For example, during a authentication performed on a website or within an application of a third-party entity, a secure authentication may be required. Instead of opening a separate application, an in-app authentication tool within the merchant's application, or an integrated authentication tool on the merchant's website may be used for the secure authentication.

In some embodiments, the user device 604 may store card reader identifying information of one or more card readers that have interactions with the user device. For example, by detecting a network communication being established between the card reader 600 and the user device, the user device may automatically retrieve and store the card reader identifier of the card reader. The user device may store the card readier identifier to be associated with user account, card information, and/or swipe characteristics obtained for the current authentication.

The mobile application 620 may be downloaded from an online store and installed on the user device 604. For example, during an initial login to use the mobile application by a user, a user account registration may be required. During the user account registration, various user account information may be mandatorily or optionally provided by the user. The user account information may include, but is not limited to, user's name, user's mailing address, user's telephone number, user's email address, user's birthdate, user's gender, user's social security number, user account login ID and password.

Furthermore, during the initial user account registration, one or more cards of the user may be registered to be associated with the user account. For example, the card information of each card may include a card type, a card issuer, a credit carrier type (e.g., Visa, Mastercard, American Express, Discover, etc.), a card number, a card expiration date, and/or a card security code. In some embodiments, the one or more cards may be requested to swipe through the card reader during the registration process, such that the encoded data in the magnetic stripe, the magnetic fingerprint data, and/or the swipe characteristics associated with the user can be obtained and stored. Additionally, the card reader identifier can also be retrieved from the card reader and stored on the user device. These types of registration information can form bases for secure authentication read for various future authentications.

A user may use the user device to perform an activity (e.g., a user login process or a transaction) associated with a third-party entity which requires an authentication using a mobile application or a web browser on the user device. During the authentication, a separate mobile application for a secure authentication read may be prompted to open on the user device. This separate mobile application may be hosted by the authentication server system or other third-party entity (e.g., a credit card company) as described in various embodiments elsewhere herein. The mobile application for secure authentication read may be displayed in parallel with or overlaid on the mobile application for the activity on the same user interface. Alternatively, the mobile application for the activity may be switched to the mobile application for secure authentication read to perform the authentication read. Alternatively, the secure authentication may be performed within the same user interface for the activity. For example, instead of opening a separate application or switching the user interface, an in-app authentication tool within the merchant's application, or an integrated authentication tool on the merchant's website may be used for the secure authentication.

A notification may be displayed within the application to request for a secure authentication. After the card is swiped through the card reader connected to the user device, the collected data may be analyzed and compared with the historic authentication data as described in various embodiments elsewhere herein.

The user device 604 may have a unique user device identifier (e.g., UDI) that distinguishes the user device 604 from any other devices. As discussed previously, the user device identifier may include a serial number of the user device, an international mobile station equipment identifier (IMEI), a mobile equipment identifier (MEID), identifying information of the various chipset within the user device, identifying information of the network communication modules (e.g., MAC address), and/or other suitable device identifiers. During the registration process and/or various authentications, the user device identifying information may be associated with the user account, the one or more cards of the user, card reader identifier, and/or other data related to the authentications. The generation and/or storage of the user device identifying information may have one or more characteristics of various embodiments of the user device described elsewhere herein. As further discussed elsewhere herein, the match or mismatch between the user device identifying information and other data related to an authentication may be used for determining whether an authentication is a fraud.

It should be understood from the foregoing that, while particular implementations have been illustrated and described, various modifications can be made thereto and are contemplated herein. It is also not intended that the invention be limited by the specific examples provided within the specification. While the invention has been described with reference to the aforementioned specification, the descriptions and illustrations of the preferable embodiments herein are not meant to be construed in a limiting sense. Furthermore, it shall be understood that all aspects of the invention are not limited to the specific depictions, configurations or relative proportions set forth herein which depend upon a variety of conditions and variables. Various modifications in form and detail of the embodiments of the invention will be apparent to a person skilled in the art. It is therefore contemplated that the invention shall also cover any such modifications, variations and equivalents.

What is claimed is:

1. A method of authenticating an online transaction or a log-in process, said method comprising:
receiving a request to perform a secure authentication step during the online transaction or the log-in process, wherein the secure authentication step is performed when a card having a magnetic stripe is swiped through a card reader;
receiving data collected about the card from the card reader, wherein said data is collected via a magnetic head on the card reader and comprises (i) a magnetic fingerprint of the magnetic stripe on the card, and (ii) at least one swipe characteristic associated with the swiping motion of the card;
receiving a card reader identifier from the card reader;
comparing, with aid of one or more processors, (1) the magnetic fingerprint of the magnetic stripe to a prestored magnetic fingerprint, (2) the at least one swipe characteristic to a prestored swipe characteristic, and (3) the card reader identifier to a prestored card reader identifier; and
determining, with the aid of the one or more processors, whether to approve or reject the online transaction or the log-in process based on a match: (1) between the magnetic fingerprint of the magnetic stripe and the prestored magnetic fingerprint, (2) between the at least one swipe characteristic and the prestored swipe characteristic, and (3) between the card reader identifier and the prestored card reader identifier.

2. The method of claim 1, wherein the transaction involves exchange of money, goods, services, or information.

3. The method of claim 1, wherein the log-in process is configured to allow a user to log in to an account to access monetary funds or information.

4. The method of claim 2, wherein the request is received from a financial institution or a customer of the financial institution, and the transaction involves transfer of an amount of money equal to or greater than a predetermined threshold amount.

5. The method of claim 4, wherein the transaction involves the transfer of the amount of money within a predetermined time period.

6. The method of claim 1, wherein the online transaction or the log-in process is approved when (1) the magnetic fingerprint of the magnetic stripe matches the prestored magnetic fingerprint, (2) the at least one swipe characteristic matches the prestored swipe characteristic, and (3) the card reader identifier matches the prestored card reader identifier.

7. The method of claim 6, wherein the online transaction or the log-in process is approved when (1) the magnetic fingerprint of the magnetic stripe matches the prestored magnetic fingerprint within a first predetermined threshold, (2) the at least one swipe characteristic matches the prestored swipe characteristic within a second predetermined threshold, and (3) the card reader identifier matches the prestored card reader identifier.

8. The method of claim 1, wherein the online transaction or the log-in process is rejected when (1) the magnetic fingerprint of the magnetic stripe does not match the prestored magnetic fingerprint, (2) the at least one swipe characteristic does not match the prestored swipe characteristic, or (3) the card reader identifier does not match the prestored card reader identifier.

9. The method of claim 8, wherein the online transaction or the log-in process is rejected when (1) the magnetic fingerprint of the magnetic stripe does not match the prestored magnetic fingerprint within a first predetermined threshold, (2) the at least one swipe characteristic does not match the prestored swipe characteristic within a second predetermined threshold, or (3) the card reader identifier does not match the prestored card reader identifier.

10. The method of claim 1, wherein the magnetic fingerprint comprises a set of magnetic characteristics defined by variations in pole-to-pole transitions and orientations of individual magnetic particles on the magnetic stripe.

11. The method of claim 1, wherein the prestored magnetic fingerprint is associated with an issued card registered with a user, and the prestored swipe characteristic is indicative of the user's swiping motion of the card through the card reader.

12. The method of claim 1, wherein the card is a payment card, and the data about the payment card further comprises at least one or more of the following: (1) payment card information comprising a payment card number, a payment card expiration date, or a payment card security code; (2) payment card user information comprising the user's personal information; and (3) a payment card financial account information comprising an account number, an institution name for the account, balance information, credit or payment limit information.

13. The method of claim 1, wherein the magnetic stripes on a plurality of different cards have different distributions of magnetic particles resulting in different magnetic fingerprints, and wherein the card reader is configured to distinguish between the plurality of different cards based on their magnetic fingerprints.

14. The method of claim 1, wherein the at least one swipe characteristic comprises a speed, direction, angle, timing, or pressure of the swipe as the card is swiped through the card reader.

15. The method of claim 1, further comprising: storing copies of the magnetic fingerprint, the at least one swipe characteristic, and the card reader identifier in a memory unit each time the card is swiped through the card reader.

16. The method of claim 11, wherein the prestored magnetic fingerprint is generated from an initial authentication read in which the user first registers the issued card by swiping the issued card through the card reader.

17. The method of claim 1, further comprising: determining a likelihood of fraud when the at least one swipe characteristic completely matches the prestored swipe characteristic.

18. A system for authenticating an online transaction or a log-in process, said system comprising:
a server in communication with a card reader operably coupled to a user device, wherein the server comprises (i) a memory for storing a prestored magnetic fingerprint, a prestored swipe characteristic, a prestored card reader identifier, and a first set of software instructions, and (ii) one or more processors configured to execute the first set of software instructions to:
receive a request from the user device to perform a secure authentication step during the online transaction or the log-in process, wherein the secure authentication step is performed when a card having a magnetic stripe is swiped through the card reader;
receive data collected about the card from the card reader or the user device, wherein said data is collected via a magnetic head on the card reader and comprises (i) a magnetic fingerprint of the magnetic stripe on the card, and (ii) at least one swipe characteristic associated with the swiping motion of the card;
receive a card reader identifier from the card reader or the user device;
compare (1) the magnetic fingerprint of the magnetic stripe to the prestored magnetic fingerprint, (2) the at least one swipe characteristic to the prestored swipe characteristic, and (3) the card reader identifier to the prestored card reader identifier; and
determine whether to approve or reject the online transaction or the log-in process based on a match: (1) between the magnetic fingerprint of the magnetic stripe and the prestored magnetic fingerprint, (2) between the at least one swipe characteristic and the prestored swipe characteristic, and (3) between the card reader identifier and the prestored card reader identifier;
wherein the user device comprises a memory for storing a second set of software instructions, and one or more processors configured to execute the second set of software instructions to:
transmit the request to the server;
receive a result indicative of an approval or a rejection of the online transaction or the log-in process; and
display the result visually on a graphical display of the user device.

19. A tangible computer readable medium storing instructions that, when executed by one or more servers, causes the one or more servers to perform a computer-implemented method for authenticating an online transaction or a log-in process, said method comprising:
receiving a request via a user device to perform a secure authentication step during the online transaction or the log-in process, wherein the secure authentication step is performed when a card having a magnetic stripe is swiped through a card reader operably coupled to the user device;
receiving data collected about the card from the card reader or the user device, wherein said data is collected via a magnetic head on the card reader and comprises (i) a magnetic fingerprint of the magnetic stripe on the card, and (ii) at least one swipe characteristic associated with the swiping motion of the card;
receiving a card reader identifier from the card reader or the user device;
comparing (1) the magnetic fingerprint of the magnetic stripe to a prestored magnetic fingerprint, (2) the at least one swipe characteristic to a prestored swipe characteristic, and (3) the card reader identifier to a prestored card reader identifier, wherein the prestored magnetic fingerprint, the prestored swipe characteristic, and the prestored card reader identifier are stored in a memory unit in communication with the one or more servers;
determining, with the aid of the one or more processors, whether to approve or reject the online transaction or the log-in process based on a match: (1) between the magnetic fingerprint of the magnetic stripe and the prestored magnetic fingerprint, (2) between the at least one swipe characteristic and the prestored swipe characteristic, and (3) between the card reader identifier and the prestored card reader identifier;
transmitting a result indicative of an approval or a rejection of the online transaction or the log-in process to the user device; and
displaying the result visually on a graphical display of the user device.
